(19) United States
(12) Patent Application Publication
(10) Pub. No.: US 2013/0119133 A1
(43) Pub. Date: May 16, 2013

(54) METHOD AND DEVICE FOR IDENTIFYING OBJECTS AND TRIGGERING INTERACTIONS BY MEANS OF CLOSE-RANGE COUPLING OF ACOUSTICALLY MODULATED DATA SIGNALS

(71) Applicants: Boxer Michael, Erlenbach (CH); Roger Lagadec, Regensdorf (CH)

(72) Inventors: Boxer Michael, Erlenbach (CH); Roger Lagadec, Regensdorf (CH)

(21) Appl. No.: 13/641,438

(22) PCT Filed: Apr. 12, 2011
(86) PCT No.: PCT/CH11/00079

§ 371 Date: Jan. 25, 2013

(30) Foreign Application Priority Data
Apr. 14, 2010 (CH) 535/10

(51) Int. Cl. G06K 7/01

(52) U.S. Cl. CPC G06K 7/01
USPC 235/439

(57) ABSTRACT

The method for identifying objects and triggering interactions functions by means of an acoustically modulated data signal, which is associated with an object, and based on the identification of the line by means of which said signal is sent from a receiving unit to a processing point. The content that is associated with said object is sent by means of said line from the processing point to the receiving unit, and thus an interaction between one of many subscribers by means of the receiving unit thereof and one of many objects is enabled. For this purpose, a station produces an acoustically modulated data signal, which is captured by the sound transducer of a receiving unit located within close range of the sound source of said station and forwarded by the receiving unit to the processing point. The processing point determines that the acoustic pattern has arrived and detects the number of the line on which this occurred. The processing point, based on the knowledge thereof of the station and of the line, provides information to the receiving unit on said line. The device for identifying objects and triggering desired interactions as described above according to said method comprises stations having a tone generator and a sound source, receiving units having a sound transducer, and a processing point. The stations are equipped with an input device, for example keys, a touchscreen, a trackball, a mouse, sensors, or a microphone for voice input.

This invention relates to:
a. means for identifying objects and triggering desired interactions comprising:
   Stations which produce an acoustically modulated data signal (acoustic pattern) by means of a tone generator and a sound source with acoustic characteristics which allow coupling only at close range
   Receiving units having a sound transducer to capture the acoustically modulated data signals produced by the said stations
   A processing point for the modulated data signals
b. A method for identifying and triggering desired interactions, in which a particular station is associated with a particular receiving unit.

Machine readable bar codes representing digital data and printed or marked directly on labels, packaging, or products are known and are currently being used to provide a product or document identification based on a fixed set of code-marks in connection with coding and scanning technologies. Bar codes can be designed in very different ways, also in two-dimensional patterns. However, all these variations have one thing in common: they are visual representations of codes that have to be read optically, i.e. the code has to be printed or made visible on a screen, and in order to read the code an optical scanner or camera is necessary.

Many devices, especially portable devices, have an audio output component designed for generating voice signals which can be perceived by human users. A wide range of input components is in use: keys, microphone, touch screen, camera, sensors or special scanners in various forms.

A solution based exclusively on acoustic signals requires that the input signals also be in acoustic form. In this context a bar code would have to be replaced by an acoustically modulated data signal. A receiving unit which is designed for acoustical input and output requires no additional optical scanning component. If a communication channel for audible signals is provided it can be used to transmit acoustically modulated data signals.

### Task of the Invention

The task addressed by the present invention is to establish a method which enables a purely acoustic interaction between one of many participants through their individual receiving unit and a station which is assigned to one of many objects. Further the present invention comprises means by which said method can be implemented.

### Solution of the Task

Said task is solved by a method which identifies objects and triggers interactions. Said method features an acoustically modulated data signal sent from a station whereby both the said data signal and the said station are associated with an object. Said method further features the identification of the line connecting the receiving unit with the processing point through which said data signal is transmitted. Content which is associated with said object is then transmitted through said line from said processing point to said receiving unit. Thus an interaction regarding one of many said objects is enabled between one of many participants and said processing point via the participant's said receiving unit.

Furthermore said task is solved by identifying objects and triggering desired interactions using acoustically modulated data signals comprising:
Stations having a tone generator and a sound source
Receiving units having a sound transducer
A processing point

This invention, its method and means and their function will be explained in detail with the help of the attached diagrams and drawings. This will illustrate the range of possible applications, achievable results, advantages and characteristics of the invention:

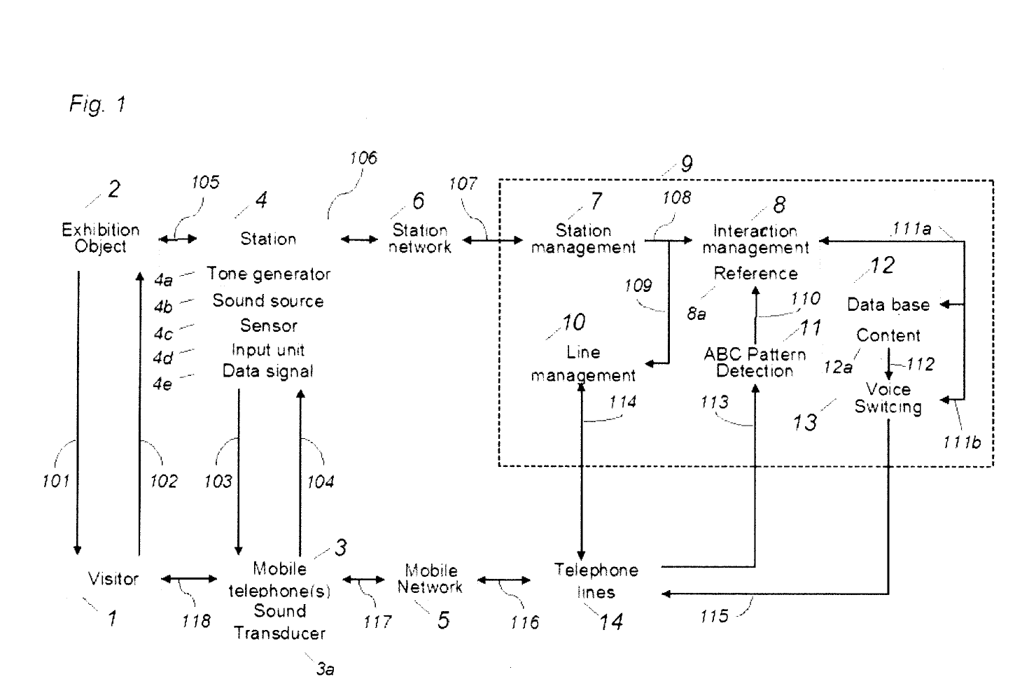

FIG. 1: Shows a synoptic diagram with all components necessary to put the method into operation,

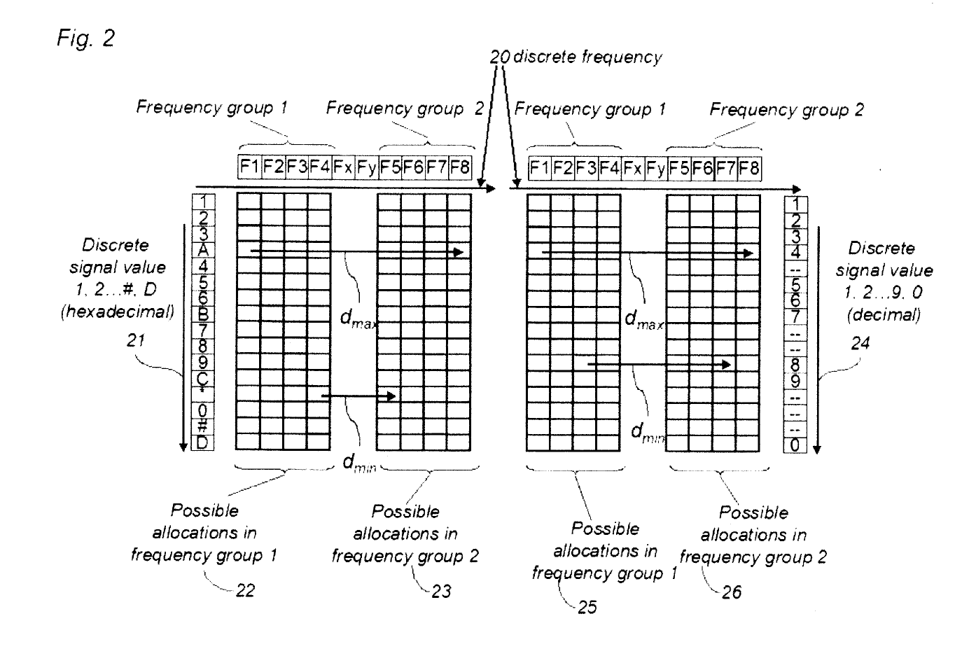

FIG. 2: Is an illustration of possible uses of discrete frequencies representing data based on hexadecimal and decimal codes respectively,

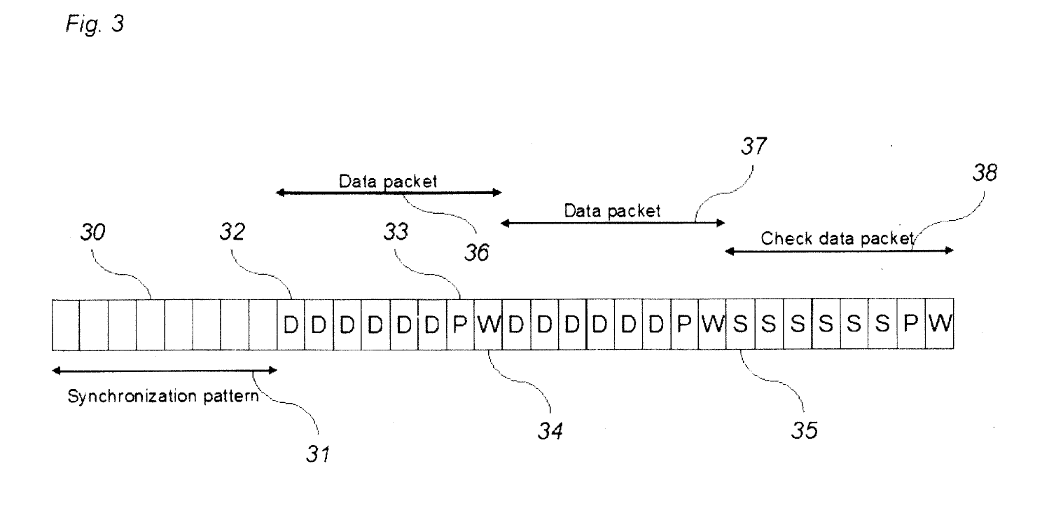

FIG. 3: Is an illustration of possible compositions of signals used to securely transfer content similar to that of a barcode by means of acoustically modulated data signals.

### BASICS

In a first step, the basic differences between an optical and an acoustical barcode will be addressed:

| Optical Bar Code | Acoustical Bar Code |
|---|---|
| Optical Bar Codes must be present in | Acoustical Bar Codes must be |
| an optically readable form, i.e. visible | present in an acoustically |
| | readable form, i.e. audible |
| The Optical Bar Codes are read by an | The Acoustical Bar Codes are read |
| optical reading device or a camera; ; | by an acoustical reading |
| this generally requires a transducer | device or a sound recorder; this |
| converting the optical signal into an | generally requires a transducer |
| electrical one | converting the acoustical signal |
| | into an electrical one |
| The Optical Bar Code is commonly | In order to be detected, the |
| present as an optically passive, | Acoustical Bar Code requires an |
| printed pattern which can only be | electrically powered circuit. The |
| read if sufficient lighting | level of illumination is |
| is provided, the surroundings or by | irrelevant. |
| the reading device | |
| Printed Optical Bar Codes are | An Acoustical Bar Code can be |
| passive and static. A dynamic | static or dynamic. It can easily be |
| response to varying parameters | modified in response to varying |
| (say, ambient illumination) is not | parameters; for example, signal |
| possible unless an active display | patterns, signal amplitude, and/or |
| is used. | signal length can be modified |
| | depending on ambient noise level. |
| Under sufficient ambient lighting, | Acoustical Bar Codes are only |
| Optical Bar Codes are always visible | perceptible as long as they are |
| even in the absence of reading | generated. This always occurs in the |
| devices. A reading device can operate | same temporal sequence and |
| reliably within a broad range of | playback speed. |
| orientations and scanning speeds. | |

The principals of transmitting data through a line using audible signals is prior art and well known from the technology of acoustic couplers. Most Applications deal with machine-to-machine communication, such as the communication between fax machines or between terminal and computer, using phone lines and ordinary telephones.

The fundamental differences between acoustic coupling as used in prior art and as used with Acoustical Bar Codes in the present invention will now be described in some detail.

| Conventional acoustic coupling | Acoustic coupling for Acoustical Bar |
|---|---|
| for data transmission | Codes |
| Acoustic couplers support | With Acoustical Bar Codes, both one- |
| simultaneous two-way coupling | way coupling and data transmission |
| and data transmission | and two-way coupling and data |
| | transmission can be selected |
| Suitable for the exchange of data | Supports the transmission of data from |
| between devices (″machine-to- | one device to another device, and the |
| machine″), but not for the exchange | independent transmission of audible |
| of information between devices and | information from a device to a human |
| humans (″man-to-machine″) | user |
| Acoustic couplers are physically | With Acoustical Bar Codes, the |
| designed for operation with | geometry of the sound source is aimed |
| conventional telephone handsets | at the possible positions of receiving |
| | devices, especially hand-held mobile |
| | phones |

### DESCRIPTION OF THE INVENTION

An object 2 is identified by identifying the acoustically modulated data signal 4e associated according to 105. This occurs with means as shown in FIG. 1, which synoptically represents a diagram of the system and its components. The data signal 4e has to be transmitted to the processing point 9 using a receiving unit 3 with a sound transducer 3a. The processing point 9 can be part of the portable receiving unit 3 or it can be connected via a transmission path (117, 5, 116, 14 and 13) or with a wireless connection. If the receiving units 3—which are represented as cell phones in the diagram—have a common processing point 9 the acoustically modulated data signals 4e will be transmitted (transmission path: 117, 5, 116, 14, and 113) detected (detection unit 11) and interpreted (interaction manager 8). Using these signals 4e and a reference 8a stored in a memory the assigned station 4 will be identified while the receiving unit 3 can be determined from the identification of the transmission path (117, 5, 116, 14 and 113) on which the signal is transmitted. On the other hand the processing point 9 can associate a receiving unit 3 which has transmitted an acoustically modulated data signal 4e to the vicinity of the station 4 which is associated with this signal 4e.

From the sequence of the different acoustically modulated data signals 4e received via the transmission path (117, 5, 116, 14 and 113), the movement of a portable receiving unit 3 relative to the stations 4 implicated in its interactions can be determined.

In addition to the transmission path (117, 5, 116, 14 and 113) via the receiving units 3, the stations 4 can be connected directly to the processing point 9 using an additional path (106, 6 and 107). This additional direct communication path has the following advantages:
1. The detection of the acoustically modulated data signals 4e becomes more reliable because the signal 4e to be detected is known a priori.
2. Additional information produced by a station 4 and/or by interaction between a station 4 and a person 1 (e.g. with an input device 4d) complementing the limited information conveyed by the acoustically modulated data signal 4e can be transmitted to the processing point 9 separately. In the absence of such a direct connection, complementary information would have to be transmitted in the form of dedicated acoustically modulated data signals.
3. If required the processing point 9 can transmit information to a station 4 which is acknowledged by this station with an acoustically modulated data signal 4e. This is specially useful in making dynamic and/or user-specific and/or secured transactions possible.

From the description above, three sets of issues of great importance for this invention result:
1. Design of the acoustically modulated data signals 4e (acoustic pattern design): In order for the data signals 4e arriving at the processing point 9 to be recognised with a high reliability they have to be designed in a way that they can be distinguished as reliably as possible from other acoustic signals and acoustic signal patterns.
2. Acoustic design of the system: In order to guarantee that a station 4 is identified and that the presence of a receiving unit 3 is determined with high reliability, it is required that the sound transducer 3a of the portable receiving unit 3 be in close proximity to the sound source 4b of the tone generator 4a. It is good practice to design for a good signal-to-noise-ratio of the acoustically modulated data signals 4e together with a minimal audibility after a short distance from the sound source 4b. Therefore the sound sources 4b have to produce a high sound pressure in a close range which diminishes quickly within a moderate distance. For this purpose it is best to use small sound sources 4b that move only a very small air column. Also an array of small sound sources 4b that are close together can be used which simultaneously transmit the same data signal 4e in phase or with a clearly defined phase relationship. An array of sound sources 4b will provide a more consistent close-range acoustic irradiation and the choice of a suited phase relationship will favour the cancelling of sound waves after a certain distance.
3. Interaction design: By means of the method described above, interactive systems such as customised information systems can be designed and operated, as illustrated in the following examples.

### EXAMPLES OF APPLICATIONS

The interactive solutions described here can provide information, guidance or navigation and can find applications in museums, collections, exhibitions, tutorial paths, sight-seeing tours, historic locations, monuments, viewpoints, tutorials, in retail business (shops, shopping malls, vending machines), in important buildings, airports and train stations as means of information, orientation, etc. This list of application areas is by no means exhaustive, and numerous other application areas can be envisaged. The core feature and the specific characteristics of this technology will always be the identification of objects and the triggering of desired interactions by means of close-range coupling of acoustically modulated data signals. Applications are also possible where input signals are fed electrically e.g. using the electrical interface of a hands-free set in a portable receiving unit.

In the following the invention, and in particular the aspect of interactive systems, will be illustrated using the special case of audio guides for museums and retail stores, and of cell phones as receiving units, as an example. FIG. 1 will be used to support the explanations.

Most museum visitors appreciate being guided through an exhibition. Conventional methods are guided tours with an expert or guide books and brochures. Experts are expensive and not always available, while walking through an exhibition reading a guide book or written comments has the disadvantage that the visitor has to constantly switch his attention between the written explanations and the exhibits—a notoriously tiring and distracting behaviour.

Guided tours with small audio devices have therefore become widespread. Their advantage is that visitors can enjoy spoken commentaries in their preferred language at any time. This way they can concentrate on the exhibits without having to read constantly. A disadvantage is these portable audio devices are expensive, and have to be serviced on a daily basis. The number of portable audio devices which have to be provided has to be equal to the maximum number of visitors who may attend the exhibition simultaneously, plus the number of devices being cleaned and recharged after use.

Visitors in a retail store or a shopping mall would like to be informed about products on offer—an important measure in increasing sales. Most shops inform their visitors acoustically through the shop's public address system. This informs all visitors at the same time rather than individually. The advantage is that of a simple and relatively inexpensive solution, but the disadvantages are often poor speech intelligibility and the lack of any possibility of informing customers individually. Visitors cannot access information in accordance with their specific needs; they cannot be addressed according to their individual customer profile; and there is no way to gather information for the purpose of customer profiling.

Cell phone based systems which are key, speech or touch-screen controlled or which work in connection with GPS data, smart phone cameras and/or pattern recognition etc. are prior art (e.g. cell phone tours). Their operation confronts the users with:
complex interactions
a lot of attention directed to the cell phone
limits regarding the cell phones that can be used, e.g. smart phones only
problems due to inaccurate determination of position using GPS

This invention introduces a new kind of interaction which overcomes the above disadvantages. It offers a cell phone based interaction suited for any cell phone, no matter of which type, independently of any special technical feature, while providing a very simple, basic and robust interaction.

If e.g. a cell phone tour (guided tour based on cell phones) is offered for an exhibition, the visitors dial the exhibition's service number, and then enters an additional code every time he wishes to hear the information sound track associated to a given exhibit. This imposed behavior is both inconvenient and distracting. The visitor must enter a code for each exhibit for which a sound track is desired; he must divide his attention between exhibits and cell phone; and he must do so under the often poor lighting conditions of exhibitions in which lighting is concentrated only on the exhibits themselves.

The solution based on this invention sets itself apart from conventional cell phone tours in particular because here data is transmitted acoustically (acoustically modulated data signals) from a cell phone to the processing point using the normal speech channel. This makes the service significantly more convenient to use, as no data has to be entered using keys or the smart phone camera etc. Mistakes made when entering the wrong code, as are common when using keypads or voice control, are eliminated. This simplified interaction makes the system very attractive for visitors.

### Means for Implementation

In the following an interactive system is described according to FIG. 1 which is made to distribute content to cell phones and which consists of following components:
Stations 4 which have a sensor 4c, which detects the presence of a cell phone 3, a tone generator 4a and a sound source 4b. The stations 4 in this example are connected to the processing point 9 via 106, 6 and 107 and generate on demand an acoustically modulated data signal 4e which is associated according to 105 to an exhibit 2 which is in close vicinity.
A mobile phone network 5
Cell phones 3 which receive an acoustically modulated data signal 4e and transmit it through the transmission path 117, 5, 116, 14, and 113 to the processing point 9.
A processing point 9 including an interaction management 8 having access 111a to a data bank 12 which manages the contents 12a and, in response to requests, sends the desired content 12a associated with exhibit 2 to the cell phone using the transmission path 112, 13 (the speech output 13 is controlled 111b by the interaction manager), 115, 14, 116, 5, and 117.

All active cell phones 3 pick up ambient noise and other acoustic signals and constantly transmit them to the processing point 9 making the task of detection more difficult. There is a probability that these interfering signals can be erroneously recognised as an acoustically modulated data signal, thus triggering an unwanted interaction.

The acoustically modulated data signals 4e need to be designed specifically in such a way that the probability of being simulated by speech, singing, noise, sound, etc is very low. This is done by giving the signals 4e characteristics (amplitude range, signal frequency, signal duration, sequence of these characteristics, signal redundancy, time stamp) which can be verified in the process of detection 11. Suitable measures for designing signals for very reliable detection and a low probability of mis-detection are known from coding theory and can be applied selectively, also taking into account the properties of the interfering signals.

If cell phones are being used as mobile receiving units 3 the particular specifications of the mobile phone system also have to be taken into consideration.

In a mobile phone network the speech channel is the only easily accessible and open transmission channel, whereas dedicated and general-purpose data channels are frequently not accessible, are not implemented, and/or require an inconvenient interaction with the user 1.

The present solution features an acoustically modulated data signal 4e consisting of a sequence of superimposed oscillations. As this data signal has to be transmitted through the speech channel of the phone network the frequencies that are being transmitted have to lie within the transmittable range, i.e. between 300 Hz and 3′400 Hz.

Because the frequencies of the human voice as well as of ambient noise also lie within this range there is, as mentioned previously, the risk that such signals might be mis-interpreted as a full data signal 4e or at least as a part of it.

With this in mind, for example, the DTMF-system (Dual Tone Multi Frequency) which has been known for many years in telephony (ETSI ES 201 235-1 Specification of Dual Tone Multi Frequency (DTMF)—Transmitters and Receivers; Part 1: General) has the following behaviour:
either DTMF-signals are being transmitted while the speech path is muted (thus suppressing all possible extraneous noise superimposed over the DTMF-signals)
or only speech signals are transmitted, while the path for possible DTMF-signals is muted

The DTMF-system comprises on the side of the transmitter a DTMF tone generator and on the side of the receiver a DTMF decoder. The generator is controlled by the phone key. The receiver consists of an electronic circuit devised to detect DTMF frequencies and a program which reconstructs the transmitted codes from the properties of the detected signals. The signals consist of two short simultaneous and superimposed signal sequences each one of which is selected from two separate groups, a low group (697 Hz, 770 Hz, 852 Hz and 941 Hz) and a high group (1209 Hz, 1336 Hz, 1477 Hz and 1633 Hz), each group providing four signaling frequencies in the middle range of speech frequencies.

In contrast with the DTMF system, which can only transmit either speech signals or DTMF signals at any given time, externally generated acoustically modulated data signals and/or noise can be transmitted simultaneously when using cell phone. There is no clear specification for the reliable detection of DTMF signals by a common DTMF receiver in the presence of speech or noise at significant levels. This means that conventional DTMF receivers can not be used under these circumstances.

There are further arguments against using conventional DTMF signals. The specified frequencies were chosen as a set of numbers that are as mutually incommensurate to each other as possible, in order to avoid interference caused by harmonic components. This means that signal sections including frequency tolerances can not have a common period. Assembling signals from pre-recorded digital signal components of finite and constant length is therefore frequently associated with discontinuities in amplitude. Furthermore a detection of DTMF signals based on a short-term discrete Fourier Transformation delivers frequency values which do not correspond to the DTMF frequencies themselves, which in turn leads to systematic measuring errors. When detecting signal frequencies over finite measuring intervals (not only but especially when using correlation detection) interfering products result. Finally transmission errors can lead to the repetition by the transmission channel of the mobile telephone network of single frames (these are sequences of samples e.g. 160 samples or 20 milliseconds with GSM). This causes signal discontinuities, generally connected to phase jumps, which can interfere massively with a correlation detection or detection with Goertzel Filters as commonly used in DTMF technology.

As, for the above reasons, existing DTMF technology is not suited for acoustic coupling, a proprietary system of frequencies and patters has been developed for the acoustically modulated data signals, which is part of this invention and is explained in FIG. 2.

It makes sense to use a new set of frequencies which are multiples of a basic frequency. This allows simple generation and switching in a fine time grid avoiding amplitude jumps. If in addition the basic frequency is equal to or a multiple of the frame frequency, repeating a frame will not cause a phase jump. Furthermore when detecting the frequency components of the data signal, detection components from other system frequencies will be exactly zero at the end of the frames, which in turn significantly increases the reliability of the detection.

With a frame frequency of 50 Hz which corresponds to a frame length of 20 milliseconds, the above considerations lead to alternatives to the DTMF frequencies using a grid based on frequencies of 50 Hz, 100 Hz, 150 Hz, etc. Instead of using the hitherto existing DTMF frequencies e.g. the following new DDTMF frequencies could be used:

DTMF

| | | | | |
|---|---|---|---|---|
| Group 1 | 697 | 770 | 852 | 941 |
| Group 2 | 1209 | 1336 | 1477 | 1633 |

DDTMF

| | | | | | |
|---|---|---|---|---|---|
| Group 1 | 700 | 800 | 900 | 1000 | 1100 |
| Group 2 | 1200 | 1300 | 1400 | 1500 | 1600 |

Further improvements are possible using DTMF-like signals. It is advantageous for example if the various possible frequency components of a signal are chosen as far apart from each other as possible. Instead of working with two superimposed frequencies, one chosen from a low group of 4 and one from a high group of 4, according to the DTMF principle, i.e. with code values according to 21 and frequency assignments according to 22 and 23, it is more advantageous to avoid combinations of high frequencies of the low group with low frequencies of the high group as is the case e.g. with frequency assignments according to 25 and 26 and a reduced assignment of value pairs to codes according to 24. It becomes apparent that deliberately imposing this restriction on the set of transferable signals which is 16 with DTMF will reduce our new set to exactly 10. This simplifies the use of the described technology for applications which are based on decimally defined data which can be found e.g. with many conventional bar codes as well as PIN codes, whereas conventional DTMF technology is basically hexadecimal. In our case, a well-justified reduction of the set of signals is achieved not through randomly or arbitrarily omitting certain frequency combinations as in the case of DTMF where e.g. the signals A, B, C, D as well as * and # are excluded but through a selection of signal combinations with good properties enhancing the robust detection of the signals. This choice of discrete frequencies which can be combined from two groups which have an ideally large distance between each other and specially suited for transmitting decimally coded data is illustrated in FIG. 2.

Based on such a definition of discrete frequencies which is suited for the transmission of acoustically modulated data signals for hexadecimally or decimally coded data, it is now possible to define data formats which improve the security of data transmission. The example in FIG. 3 illustrates this principle. The entire signal sequence consists solely of the signal components 30 which are one data frame long, i.e. 20 milliseconds when using GSM frames to which the above described pairs of frequencies are allocated with the exception of the synchronising pattern 31. The synchronising pattern 31 consists of a suited sequence of frames containing a single frequency which is not part of the two groups (low and high) i.e. 1100 Hz, 1200 Hz and empty frames respectively e.g. 1 empty frame followed by 2 frames with 1200 Hz followed by 2 empty frames followed by 2 frames with 1200 Hz plus one empty frame. These signals can be detected with the same method used to detect data signals, and in addition it is possible to determine the frame border's time alignment from the detected signals. The synchronising patterns are followed by data packets 36 which contain only frames with frequency pairs. Each data packet contains user data on the one hand and data which is calculated as check sum of the user data (33, 34) on the other hand. As a special case a data packet can be transmitted with a data load representing the check sum of the user data of another data packet. This allows a better fault correction in the case of continuous transmission interferences. Determining suitable synchronising patterns and choosing suited codes for fault protection is known to professionals and therefore a detailed description is not necessary.

In order to make sure that a cell phone 3 is in close range of a station 4 thus reducing the probability that noise would trigger off an interaction by mistake, the presence of the phone 3 can be detected by the station 4. The information that a station 4 has detected a cell phone 3 is transmitted to the processing point 9 and used as a condition in connection with the arrival of the respective data signal to trigger off the transmission of the respective content. This can be done without a functional interaction specific to mobile telephony e.g. by activating a sensor 4c (mechanical switch, proximity switch, ultrasonic sound sensor, infrared sensor, optical sensor, capacitive or inductive detection, detection of the radiation of the receiving unit, detection with the help of radar, etc.). The combined use of different sensors 4c is also possible. If no information is provided regarding the presence of a cell phone all lines have to be monitored constantly with regards to the arrival of an acoustically modulated data signal 4e whereas if information regarding presence is gathered centrally the monitoring data signals 4e can be reduced to a short span of time slightly longer than the data signal 4e. Noise which might simulate data signals 4e appearing outside the measuring window will be suppressed effectively. It is also very advantageous that a data signal 4e has to be detected only when coming from a station 4 which has detected and signaled the presence of a cell phone. The signal which has to be detected is known a priori.

Further test procedures are possible in order to avoid a misdetection. A visitor who was detected with a high probability e.g. at exhibit No. 3 will not be able to suddenly appear 10 seconds later at exhibit No. 96 in a remote wing of the museum. The coordinates of the stations 4 and the sequence of their use can also contribute to reducing the probability of a misdetection.

The following outlines an interaction using an exhibition as an example. A visitor 1 would like to obtain spoken information 12a associated with exhibit 2 on his cell phone 3.
The cell phone has to be switched on
Visitor 1 has to have dialed a service phone number of the processing point 9 and therefore to have his cell phone connected to this processing point 9 through a phone line which has been allocated by the line management 10.

Close to the exhibit 2 there is a station 4 with a tone generator 4a and a sound source 4b (loudspeaker, sound transducer) which produces an acoustic signal which identifies the exhibit 2 (as well as a special form of interaction, language . . . if such features are offered). If the microphone 3a of a cell phone 3 is held close to the sound source 4b the acoustically modulated data signal 4e is transmitted to the processing point 9. There it will be recognised even in the presence of a significant level of noise. Based on the detection 11 of the specific data signal 4e and on the identity of the specific line 14 on which it has been detected, it becomes clear that visitor 1 with his cell phone 3 is specifically requesting on his line 14 the content 12a associated with the exhibit 2 and the corresponding spoken comment 12a can be transmitted. As a result, visitor 1 is supplied the desired information 12a.

It is necessary for the allocation of the data signal 4e to the line 14 to be performed reliably i.e. the correctly allocated comment 12a for an exhibit 2 has to be supplied on the correct line to the visitor 1 who has asked for this content.

Even though in many cases the system will be aware of the phone number of visitor 1 occupying line 14, explicit knowledge of this phone number is in no way required.

As it is not known, prior to the detection 11, on which line 14 the data signal will be recognised, it is necessary to constantly check all lines 14 for the possible appearance of any data signal 4e.

A station 4 can also feature a menu offering interactions for visitor 1 to choose from. This menu could be available in tactile (e.g. keys) ore virtual (e.g. touch screen) form. The menu can e.g. refer to:
A number of objects 2 (one station 4 in the vicinity of a group of objects).
A changing object 2 e.g. information referring to each slide of a running presentation.
An object 2 for which a number of contents is available e.g. a short and a long comment or a more detailed description of the history of the object 2.
   If the station 4 is connected to the processing point 9 the choice from the menu can be transferred to the processing point 9 and the desired content 12a can be transferred to the respective visitor 1 whereby this station 4 can always produce the same acoustic pattern 4e. But the station 4 can also receive from the processing point 9 a totally or partly specific acoustic pattern associated to the selection from the menu.

In this case the station 4 serves to identify the line, and can optionally also serve to determine the actual content 12a associated with the interaction.

The following examples of applications require the stations 4 to be directly connected to the processing point 9:

A further form of interaction is e.g. a solution for customers or visitors in which a guided tour or a set of information is personalized. Here some examples:
Somebody wants to visit the Louvre in Paris, France, but in the form of a guided tour with the most important objects 2, within a tight time schedule (30 minutes) and with the corresponding commentary 12a. From the menu of the station 4 at the entrance he selects the fast tour (duration 30 minutes) and is led on this personalized guided tour from one exhibit 2 to the next, receiving the corresponding spoken commentary 12a as well as directions guiding him to the next exhibit 2, thanks to his cell phone 3 and the acoustical patterns of the visited stations 4.
Somebody visiting a large collection only wants to see a selection of exhibits 2 in connection with a certain topic. From the menu of a station 4 at the entrance he selects the desired topic or puts together his tour with the help of search terms and is then led on this personalized guided tour from one exhibit 2 to the next, again receiving the corresponding spoken commentary 12a as well as directions guiding him to the next exhibit 2, thanks to his cell phone 3 and the acoustical patterns of the visited stations 4.
Somebody is in a large supermarket and wants to do some shopping quickly. As we all know this can become a very annoying task especially if in an unfamiliar supermarket. From the menu of a station 4 at the entrance the customer selects the desired goods 2, and is then led through the store with the help of directions guiding him directly from one item location to the next through his cell phone 3 and the acoustical patterns of the visited stations 4. If an item 2 is not in stock this can be indicated right at the beginning and alternatives can be offered. In addition the customer's attention can be drawn to special offers, or to offers matching his profile, as he can be identified though his mobile phone number. As an extra service, if customer 1 is on line with his cell phone 3 he can e.g. be put through to his partner at home who he then can ask if anything else is required, whether he should take advantage from a special offer or buy the organic instead of the regular product, etc etc etc.

The applications described here serve to enable interactions according to customer's requests and choices.

1-13. (canceled)

14. A method for identifying objects and triggering interactions, comprising the steps of:
acoustically modulating a data signal associated with an object of a plurality of objects; and,
identifying a line through which said data signal is transmitted from a receiving unit to a processing unit for enabling an interaction between one participant of a plurality of participants via said receiving unit and the object.

15. The method for identifying objects and triggering interactions according to claim 14, wherein said step of acoustically modulating a data signal associated with an object includes a station for producing the acoustically modulated signal captured by a sound transducer of said receiving unit located within range of a sound source of said station and transmitted by said receiving unit to a processing point, wherein the processing point determines that an acoustic pattern has arrived and detects a number of the line on which the acoustic pattern has arrived, the processing unit, on the basis of the station and the line, provides information on the line so that a desired interaction occurs.

16. The method for identifying objects and triggering interactions according to claim 15, further comprising step of:
the processing point constantly scanning all lines in search of possible occurrences of acoustically modulated data signals.

17. The method for identifying objects and triggering interactions according to claim 16, further comprising the steps of:
the processing point detecting an occurrence of an acoustically modulated data signal;
determining the line through which the acoustically modulated data signal has arrived;
determining with which object the acoustically modulated data signal is associated and the content of the object associated therewith; and,
providing said receiving unit with content of the acoustically modulated data signal that the processing point has detected in said detecting step.

18. The method for identifying objects and triggering interactions according to claim 15, wherein said station detects a presence of a receiving unit signaling to the processing point for detecting a potential occurrence of the acoustic pattern based upon a priori knowledge of said station and the acoustic pattern associated therewith.

19. The method for identifying objects and triggering interactions according to claim 15, further comprising the step of:
the processing unit transmitting information indicating either success or failure of an interaction with a user depending upon characteristics of the acoustic pattern received.

20. The method for identifying objects and triggering interactions according to claim 15, further comprising the step of:
the processing point transmitting information to said station, thereby causing said station to send back to the processing point an acoustic pattern.

21. The method for identifying objects and triggering interactions according to claim 15, wherein a plurality of acoustic patterns are arranged chronologically via concatenation of sums of segments, a length of which is equal to a length, or a multiple of the length, of a speech processing frame of a digital speech transmission network and the segment frequency equals a multiple of a frequency of a frequency of the speech processing frame, wherein each said segment frequency lies within an effective bandwidth of digital speech transmission networks.

22. The method for identifying objects and triggering interactions according to claim 21, wherein individual said segments are subjected to soft keying before being assembled for forming a resulting acoustically modulated data signal.

23. The method for identifying objects and triggering interactions according to claim 21, wherein zero-valued signal sections are used.

24. The method for identifying objects and triggering interactions according to claim 15, wherein objects are identified and the desired interaction is triggered by acoustically modulated data signals with an amplitude within a range for signal processing only if captured in proximity of the sound source, featuring signals consisting of two frequencies, a first frequency of said two frequencies being selected from a low group and a second frequency of said two frequencies being selected from a high group, each of said low group and said high group providing four signaling frequencies, provided that six signals consisting of the highest frequencies of said low group combined with the lowest frequencies of said high group are not being used when transmitting decimal data.

25. Apparatus for identifying objects and triggering desired interactions, comprising:
means for acoustically modulating data signals for identifying and triggering desired interactions by acoustically modulating data signals with an amplitude within a range for signal processing only if captured in close proximity of a sound source; and,
a plurality of stations having input components.

26. The apparatus for identifying objects and triggering desired interactions according to claim 25, wherein said plurality of stations are electrically coupled with an input interface of a mobile telephone used as a receiving unit.

27. The apparatus for identifying objects and triggering desired interactions according to claim 25, wherein said plurality of stations are electrically coupled with an output interface of a mobile telephone used as a receiving unit.

28. The apparatus for identifying objects and triggering desired interactions according to claim 25, wherein said plurality of stations are is a plurality of mobile telephones as receiving units connected to a public mobile telephone network with a speech channel thereof capable of being used for transmitting the acoustically modulated data signals.

29. The apparatus for identifying objects and triggering desired interactions according to claim 25, further comprising:
a plurality of receiving units between said plurality of stations; and,
a processing point through which a presence of a receiving unit of said plurality of receiving units and an identity of a triggered station of said plurality of stations is able to be signaled to the processing point.
